(19) United States
(12) Patent Application Publication
(10) Pub. No.: US 2007/0133225 A1
(43) Pub. Date: Jun. 14, 2007

(54) Lighting unit, electro-optic device, and electronic apparatus

(76) Inventor: Toyohiro Sakai, Azumino-shi (JP)

Correspondence Address: HARNESS, DICKEY & PIERCE, P.L.C., P.O. BOX 828, BLOOMFIELD HILLS, MI, 48303, US

(21) Appl. No.: 11/637,197

(22) Filed: Dec. 11, 2006

(30) Foreign Application Priority Data
Dec. 12, 2005 (JP) 2005-357258

(51) Int. Cl. F21V 7/04

(52) U.S. Cl. 362/600

(57) ABSTRACT

A lighting unit includes a planar lighting component that emits illuminating light; a first light deflector having a prismatic face on one surface, the first light deflector being disposed on the planar lighting component; a second light deflector having a prismatic face on one surface, the second light deflector being disposed on the first light deflector, wherein the one surface of the first light deflector is opposite the one surface of the second light deflector, and the direction of tilt of the prismatic face of the first light deflector is perpendicular to the direction of tilt of the prismatic face of the second light deflector.

The entire disclosure of Japanese Patent Application No. 2005-357258, filed Dec. 12, 2005 is expressly incorporated by reference herein.

### BACKGROUND

1. Technical Field

The present invention relates to a lighting unit, an electro-optic device, and an electronic apparatus. In particular, the invention relates to the structure of a lighting unit having a light-deflecting surface provided with tilted prismatic faces.

2. Related Art

Various types of electro-optic devices, such as liquid-crystal displays, included in electronic apparatuses having various displays have viewing-angle properties in which light that emerges from a screen in the direction of the normal to the screen has the maximum luminance level, and a luminance level decreases with increasing exit angle (angle with respect to the normal to the display). In particular, in mobile electronic apparatuses, such as cellular phones, personal digital assistants, and mobile computers, demands for a reduction in power consumption results in the limitation of the luminance level of illuminating light emitted from a backlight. To efficiently use illuminating light for display, for example, Japanese Unexamined Patent Application Publication No. 60-70601 (Patent Document 1) discloses an optical sheet for allowing the exit angle distribution of luminance of the illuminating light from the backlight to concentrate in a region along or close to the direction of the normal to the screen.

As described in Patent Document 1, such an optical sheet is typically used as follows: two light-collecting sheets each including a smooth surface and a corrugated light-deflecting surface having prismatic faces, are disposed, the prismatic faces each being disposed at an angle of 45° to the corresponding smooth surface, adjoining prismatic faces facing different directions, each of the smooth surfaces facing the backlight side, and each of the light-deflecting surfaces facing a liquid-crystal display, wherein the two light-collecting sheets are disposed in a manner such that the direction of the corrugation of each light-deflecting surface are perpendicular to each other. When the two light-collecting sheets are stacked and then used, the peak of the luminance is observed in the direction of the normal to the screen (in the direction at an exit angle of zero) with respect to the exit angle distribution of luminance. Furthermore, the luminance level decreases with increasing exit angle toward all directions other than the normal direction.

In the above-described electro-optic apparatus, a viewer may visually identify an image displayed on the screen in an oblique direction with respect to the normal to the screen as well as in the direction of the normal to the screen. For example, when an in-car display is mounted at the middle portion in a car in the width direction in such a manner that a screen faces toward the rear of the car, passengers visually identify an image displayed on the screen of the in-car display from right and left oblique directions. In recent years, a multi-image display in which different images are visually identified by viewing the screen in different viewing angle ranges has been developed. For example, it is known that a method for visually identifying different images in different viewing angle ranges by applying the same principle as a three-dimension-image display described in Japanese Unexamined Patent Application Publication No. 3-119889 (Patent Document 2), for example, by employing a method of using a parallax barrier. A known example of the multi-image display is a vehicle-mounted two-image display in which passengers sitting at both sides of the display can view different images, for example, a video image and a navigation image.

However, in cases where an image displayed on the screen is viewed from right and left oblique directions and where different images are viewed in different viewing angle ranges, light uselessly emanates in the direction of the normal to the screen, and the brightness of an image may be disadvantageously insufficient when the image is viewed from right and left oblique directions since the viewing angle distribution of luminance of light emitted from an lighting unit, such as a backlight, concentrates in a small-viewing-angle region (along or close to the direction of the normal to the screen) as described above.

### SUMMARY

An advantage of some aspects of the invention is that there is provided a lighting unit that can suppress a decrease in light-use efficiency and brighten an image when viewed from a direction inclined with respect to the normal to a screen or different directions; and an electro-optic device.

A lighting unit according to a first aspect of the invention include a planar lighting component that emits illuminating light; a first light deflector having a prismatic face on one surface, the first light deflector being disposed on the planar lighting component; a second light deflector having a prismatic face on one surface, the second light deflector being disposed on the first light deflector, wherein the one surface of the first light deflector is opposite the one surface of the second light deflector, and the direction of tilt of the prismatic face of the first light deflector is perpendicular to the direction of tilt of the prismatic face of the second light deflector.

According to the first aspect of the invention, the illuminating light emitted from the planar lighting component is deflected by passing the illuminating light through the first or second light deflector in which the one surface is disposed adjacent to the planar lighting component to diffuse the illuminating light. Then, the illuminating light is deflected by passing the illuminating light through the first or second light deflector in which the one surface is opposite the planar lighting component to collect the illuminating light toward the optical axis. Thus, it is possible to achieve luminance distribution in which light diffuses in a predetermined viewing angle direction and converges in the direction intersecting with the predetermined viewing angle direction.

Specifically, for example, the lighting unit preferably include the planar lighting component that emits the illuminating light; the first light deflector disposed at the outgoing light side of the planar lighting component, the first light deflector having a first deflecting surface provided with prismatic faces tilted with respect to a first direction, directions of tilt of adjoining prismatic faces being opposite, and the first deflecting surface being disposed adjacent to the planar lighting component; the second light deflector disposed at the outgoing light side of the planar lighting component, the second light deflector having a second deflecting surface provided with prismatic faces tilted with respect to a second direction intersecting with the first direction, directions of tilt of adjoining prismatic faces being opposite, and the second deflecting surface being disposed at the opposite side of the planar lighting component. In this case, any one of the first and second light deflectors may be disposed adjacent to the planar lighting component.

A lighting unit according to a second aspect of the invention includes a planar lighting component that emits illuminating light; a first light deflector disposed adjacent to an outgoing light side of the planar lighting component, the first light deflector deflecting the illuminating light in such a manner that the exit angle distribution of luminance along a first direction has at least two peak ranges separated from each other; and a second light deflector disposed adjacent to an outgoing light side of the planar lighting component, the second light deflector deflecting the illuminating light in such a manner that the exit angle distribution of luminance along a second direction intersecting with the first direction concentrates in a small-exit-angle region. Also in this case, any one of the first and second light deflectors may be disposed adjacent to the planar lighting component.

According to the second aspect of the invention, the illuminating light emitted from the planar lighting component is subjected to a step of passing the illuminating light through the first light deflector to deflect the illuminating light. The illuminating light is subjected to a step of passing the illuminating light through the second light deflector to deflect the illuminating light. The steps may be performed in any order. Then, the illuminating light emerges from the lighting unit. The illuminating light is deflected with the first deflector to form the exit angle distribution of luminance along the first direction having the at least two peak ranges separated from each other. Furthermore, the illuminating light is deflected with the second deflector. Thereby, the exit angle distribution of luminance along the second direction concentrates in a small-exit-angle region (angles close to the direction of the normal). Thus, it is possible to form the luminance distribution having the at least two peak ranges along the first direction while ensuring the brightness of the illuminating light.

According to the second aspect of the invention, the two peak ranges preferably extend at both sides of a region with an exit angle of zero degree. Thus, the lighting unit has suitable lighting properties for visually identifying an image when viewed from right and left directions with respect to the direction of the normal to the screen.

According to the second aspect of the invention, the minimum value of luminance between the two peak ranges is preferably less than the half-width of a peak value. Thus, when the lighting unit is used for a display having the function of displaying two images, it is possible to clarify the boundary between different images.

According to the second aspect of the invention, preferably, the planar lighting component includes a light guide having an emergent face and an entrance face facing to a direction different from the emergent face; and a light source facing the entrance face, wherein the propagation direction of light from the light source through the entrance face is substantially identical to the second direction. Light emitted from the light source enters the light guide through the entrance face and emerges from the emergent face by appropriate light-deflecting means. In general, the exit angle distribution of the illuminating light along the propagation direction is widely dispersed compared with distribution along another direction. Thus, when the propagation direction is substantially identical to the second direction, light widely diffused along the second direction emerges from the light guide and is collected with the second light deflector. The first light deflector deflects light in accordance with the exit angle distribution along the first direction different from the second direction. Thus, a desired exit angle distribution along the first direction can be formed controllably and efficiently.

An electro-optic device according to a third aspect of the invention includes any one of the lighting units described above; and an electro-optic display disposed adjacent to the outgoing light side of the lighting unit, wherein the electro-optic display has a pair of substrates, and an electro-optic material disposed between the substrates.

According to the third aspect of the invention, preferably, the electro-optic display displays different images in two different viewing angle ranges, and the lighting unit has peaks of luminance in exit angle ranges corresponding to the two viewing angle ranges.

The electro-optic device can be mounted on any type of electronic apparatus. Examples thereof include mobile electronic apparatuses, such as cellular phones, mobile computers, and mobile electronic watches; and in-car electronic apparatuses, such as car navigation systems, in-car television sets, and in-car imaging monitors.

### BRIEF DESCRIPTION OF THE DRAWINGS

The invention will be described with reference to the accompanying drawings, wherein like numbers reference like elements.

FIG. 1 is a schematic longitudinal sectional view of the entire structure of a lighting unit according to an embodiment.

FIG. 2 is a schematic longitudinal sectional view of the entire structure of the lighting unit according to the embodiment, the view being taken along a plane perpendicular to the section in FIG. 1.

FIG. 3 is a schematic plan view of the entire structure of the lighting unit according to the embodiment.

FIG. 4 is a schematic longitudinal sectional view of the entire structure of an electro-optic device including a lighting unit according to an embodiment.

FIG. 5 is a cross-sectional view illustrating an example of an optical sheet.

FIG. 6 is a cross-sectional view illustrating an example of another optical sheet.

FIG. 7 is a cross-sectional view illustrating an example of another optical sheet.

FIG. 8 is a schematic longitudinal sectional view of another example of an electro-optic device including a lighting unit according to an embodiment.

FIG. 9 shows graphs illustrating the luminance distribution of a generally known lighting unit.

FIG. 10 shows graphs illustrating the luminance distribution of a lighting unit according to an embodiment.

FIG. 11 shows graphs illustrating the luminance distribution of a lighting unit according to another embodiment.

FIG. 12 shows graphs illustrating the luminance distribution of a lighting unit according to another embodiment.

FIG. 13 shows graphs illustrating the luminance distribution of a lighting unit according to a comparative embodiment.

FIG. 14 is a schematic perspective view of an appearance of an electronic apparatus.

### DESCRIPTION OF EXEMPLARY EMBODIMENTS

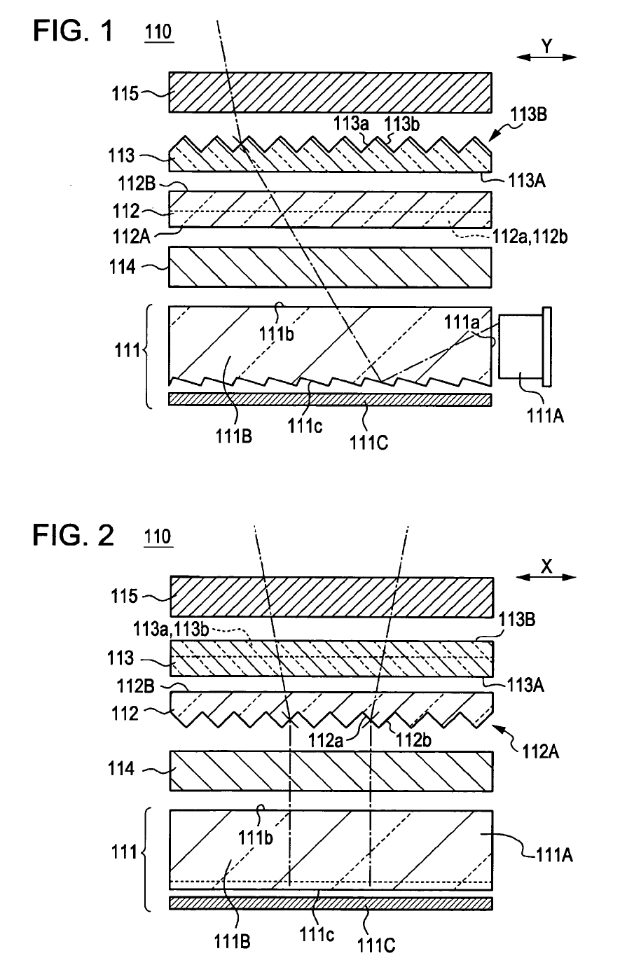

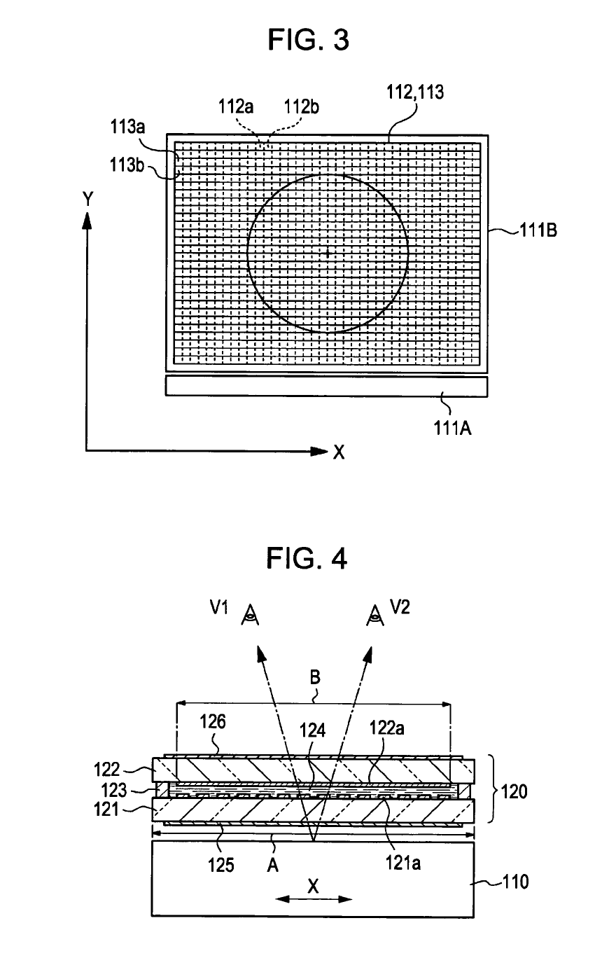

Embodiments of the invention will be described in detail below with reference to accompanying drawings. FIG. 1 is a schematic longitudinal sectional view of the entire structure of a lighting unit 110 according to an embodiment. FIG. 2 is a schematic longitudinal sectional view of the lighting unit 110. The view is taken along a plane perpendicular to the section in FIG. 1. FIG. 3 is a schematic plan view of the lighting unit 110.

The lighting unit 110 includes a planar light source 111 having a planar illuminating area; a first optical sheet 112 disposed adjacent to the outgoing light side of the planar light source 111; and a second optical sheet 113, the first optical sheet 112 being disposed between the second optical sheet 113 and the planar light source 111. A light diffuser 114 is disposed between the electronic component 11 and the first optical sheet 112. A polarized light separator 115, such as an absorption polarizer or a reflection polarizer, is disposed above the second optical sheet 113. The light diffuser 114 and the polarized light separator 115 are disposed to improve the uniformity of luminance of illumination light emitted from the planar light source 111 or to provide a unit to be illuminated, e.g., a liquid-crystal panel, with linearly polarized light and to remove or reuse excess polarized light components. Thus, the light diffuser 114 and the polarized light separator 115 are not necessarily required for the principal operation of the embodiment. The light diffuser 114 and the polarized light separator 115 may be omitted.

The planar light source 111 includes a light source 111A having a point light source, such as a light-emitting diode (LED), or a line light source, such as a cold-cathode tube; and a light guide 111B in which light emitted from the light source 111A is incident on an entrance face 111a (end face) and then gradually emerges from an emergent face (top face) 111b while the incident light propagates in the Y-direction (a second direction, i.e., the direction parallel to the paper plane in the FIG. 1 and perpendicular to the paper plane in the FIG. 2) therethrough. The light guide 111B has a plurality of light-deflecting slopes 111c disposed on the bottom face opposite the emergent face 111b, the light-deflecting slopes 111c deflecting the propagating light toward the emergent face 111b. A reflector 111C is disposed on the bottom face of the light guide 111B.

The first optical sheet 112 and the second optical sheet 113 are each composed of a transparent resin material, such as a polyester resin, a polyethylene resin, an acrylic resin, or a polycarbonate resin. Alternatively, each of the first and second optical sheets 112 and 113 may be composed of optical glass or any other resin material. The material constituting each sheet preferably has a refractive index of 1.3 to 1.7 and more preferably 1.5 to 1.6. Excessively low refractive indices result in an insufficient effect of deflecting light at the light-deflecting surface. In contrast, excessively high refractive indices result in difficulty in the availability of a material, thus increasing material costs or degrading other properties, such as light transmittance, impact resistance, resistance to damage, and durability.

The first optical sheet 112 has a first light-deflecting surface 112A adjacent to the planar light source 111; and a smooth surface 112B, from which light emerges, opposite the first light-deflecting surface 112A. The first light-deflecting surface 112A has a pair of prismatic faces 112a and 112b, each of the prismatic faces 112a and 112b being tilted with respect to the X-direction (a first direction, i.e., the direction perpendicular to the paper plane in FIG. 1 and parallel to the paper plane in FIG. 2). Both of the prismatic faces 112a and 112b are tilted with respect to the X-direction. However, the prismatic face 112b. The prismatic faces 112a and 112b are alternately arranged on the first light-deflecting surface 112A along the X-direction. The first light-deflecting surface 112A is disposed at the interface where a refractive index increases in a propagation direction of the illuminating light, i.e., the first light-deflecting surface 112A is disposed at the interface between air and the first optical sheet 112.

The second optical sheet 113 has a smooth surface 113A adjacent to the planar light source 111; and a second light-deflecting surface 113B, from which light emerges, opposite the smooth surface 113A. The second light-deflecting surface 113B has a pair of prismatic faces 113a and 113b, each of the prismatic faces 113a and 113b being tilted with respect to the Y-direction. Both of the prismatic faces 113a and 113b are tilted with respect to the Y-direction. However, the direction of tilt of the prismatic face 113a is opposite that of the prismatic face 113b. The prismatic faces 113a and 113b are alternately arranged on the second light-deflecting surface 113B in the Y-direction. The second light-deflecting surface 113B is disposed at the interface between the interface where a refractive index decreases in the propagation direction of the illuminating light, i.e., the second light-deflecting surface 113B is disposed at the interface between the second optical sheet 113 and air.

Each of the X-direction and the Y-direction lies in a plane normal to the optical axis. In this embodiment, the X-direction is orthogonal to the Y-direction. However, the orthogonal relation is not necessarily complete. In this case, the crossing angle of the X-direction and the Y-direction is preferably in the range close to 90°, for example, 60° to 120° and more preferably 80° to 100°. In the case of a crossing angle away from 90°, for example, in the range of 30° to 60°, at least two second optical sheets are preferably disposed, the sheets facing different directions to each other.

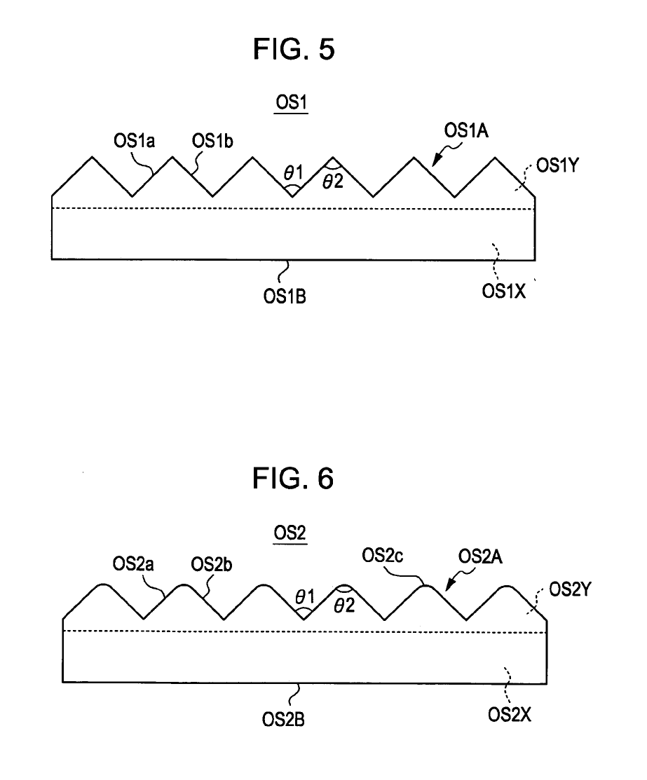

Various types of optical sheet shown in FIGS. 5 to 7 may be used as the first optical sheet 112 and the second optical sheet 113. An optical sheet OS1 shown in FIG. 5 has a light-deflecting surface OS1A and a smooth surface OS1B. Tilted prismatic faces OS1a and OS1b are alternately arranged on the light-deflecting surface OS1A, the direction of tilt of the prismatic face OS1a being opposite that of the prismatic face OS1b. The prismatic faces OS1a and OS1b each extend in the direction perpendicular to the paper plane of the corresponding figure. The prismatic faces are arranged in a striped pattern as a whole. Angles θ1 and θ2 between the prismatic faces OS1a and OS1b are each 90°. The prismatic faces OS1a and OS1b are each disposed at an angle of 45° to the smooth surface OS1B. In this prismatic structure, the prismatic faces OS1a and OS1b are connected to each other. Top portions and valley portions formed by connection of the prismatic faces OS1a and OS1b substantially constitute linear edge lines and grooves.

The optical sheet OS1 may be composed of a single transparent material. Alternatively, the optical sheet OS1 may include a base film layer OS1X composed of a polyester resin or the like having relatively high transparency; and a prismatic layer OS1Y composed of an acrylic resin, a polycarbonate resin, or the like having a relatively high refractive index, the prismatic layer OS1Y being laminated on the base film layer OS1X, as represented by a dotted line in the figure.

An optical sheet OS2, which is basically the same as above, shown in FIG. 6 includes a light-deflecting surface OS2A having prismatic faces OS2a and OS2b and a smooth surface OS2B, the prismatic faces OS2a and OS2b being arranged. Angles θ1 and θ2 between the prismatic faces are the same as above. The angle of each of the prismatic faces with respect to the smooth surface is also the same as above. The difference between the optical sheet OS2 and the optical sheet OS1 is that top portions defined by the prismatic faces OS2a and OS2b do not constitute edge lines but convex surfaces OS2c. This improves cutoff properties of an exit angle and results in the generation of illuminating light components in high-exit-angle regions, thereby achieving wide viewing angle properties. A prismatic layer OS2Y may be laminated on a base film OS2X in the same way as above.

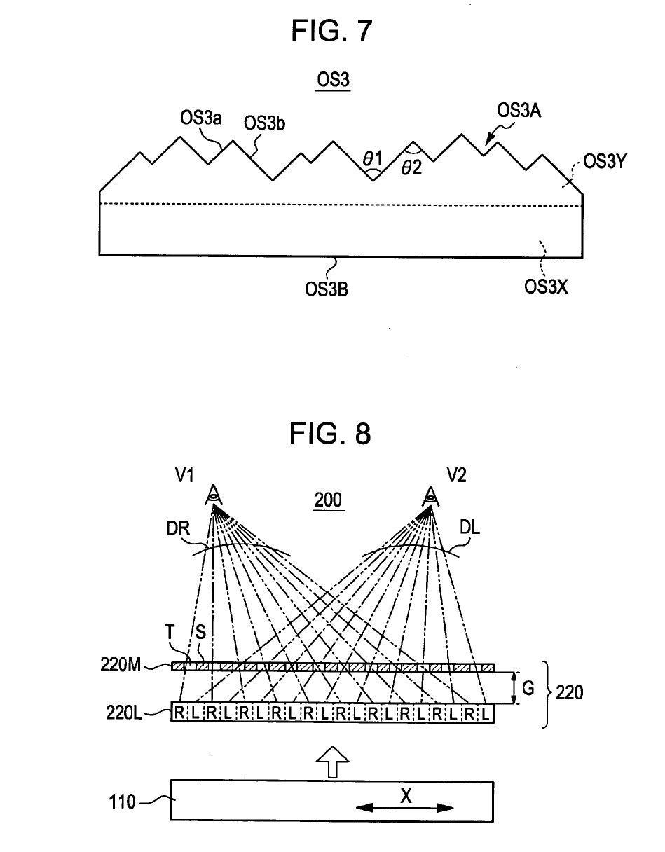

An optical sheet OS3, which is basically the same as above, shown in FIG. 7 includes a light-deflecting surface OS3A having prismatic faces OS3a and OS3b and a smooth surface OS3B, the prismatic faces OS3a and OS3b being arranged. Angles θ1 and θ2 between the prismatic faces are the same as above. The angle of each of the prismatic faces with respect to the smooth surface is also the same as above. Differences between the optical sheet OS3 and the optical sheet OS1 are that the periodic interval of the prismatic structure on the light-deflecting surface OS3A has a random pattern; heights of the top portions are nonconstant; and depths of the valley portions are nonconstant. This can prevent image blurring and the occurrence of moire fringes. A prismatic layer OS3Y may be laminated on a base film OS3X in the same way as above.

The optical sheet has a thickness of about 50 to about 200 μm. The prismatic structure has a periodic interval of about 10 to about 80 μm and preferably about 20 to about 60 μm. Optical uniformity is enhanced with decreasing periodic interval. However, the periodic interval needs to be determined so as not to generate moiré fringes in relation to the pixel arrangement of an electro-optic display. A decrease in periodic interval increases the number of the top portions and valley portions in the prismatic structure, thus relatively reducing light-collecting properties.

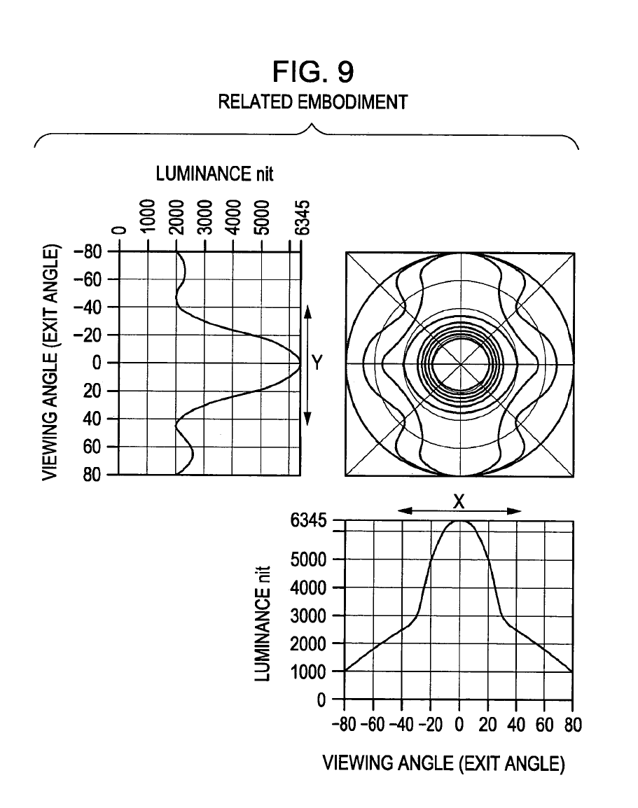

Outgoing light properties of the lighting unit described above will be described below with reference to FIGS. 9 to 14. 'FIGS. 9 to 14 each show (a) a distribution map illustrating the entire viewing angle distribution of luminance corresponding to the exit angle distribution of luminance of the lighting unit; (b) a graph illustrating the exit angle distribution of luminance along the X-direction in the distribution map; and (c) a graph illustrating the exit angle distribution of luminance along the Y-direction.

### Related Embodiment

FIG. 9 shows data in relation to a known lighting unit that includes the planar light source 111 shown in FIGS. 1 and 2; the light diffuser 114 disposed adjacent to the emergent face of the planar light source 111; a first optical sheet OS1 shown in FIG. 5, the first optical sheet OS1 being disposed adjacent to the viewing side of the light diffuser 114 in such a manner that the smooth surface of the first optical sheet OS1 is disposed adjacent to the planar light source, the light-deflecting surface of the first optical sheet OS1 is disposed adjacent to the viewing side, and that the prismatic faces face toward the X-direction; a second optical sheet OS1 shown in FIG. 5, the second optical sheet OS1 being disposed adjacent to the viewing side of the first optical sheet OS1 in such a manner that the smooth surface of the second optical sheet OS1 is disposed adjacent to the planar light source, the light-deflecting surface of the second optical sheet OS1 is disposed adjacent to the viewing side, and that the prismatic faces face toward the Y-direction; and the polarized light separator 115 disposed adjacent to the viewing side of the second optical sheet, the polarized light separator 115 being a reflection polarizer, which transmits a polarization component parallel to a predetermined direction and reflects a polarization component orthogonal to the predetermined direction.

With respect to the luminance distribution in the related embodiment, the peak of the luminance level is observed in the direction of the normal to the screen (in the direction at a viewing angle of zero degree). Furthermore, the luminance level decreases with increasing viewing angle toward all directions. Thus, both of the luminance distribution along the X-direction and the luminance distribution along the Y-direction exhibit a typical single-peaked pattern. The half-width of the peak of the luminance is 60° (−30° to +30°).

### First Embodiment

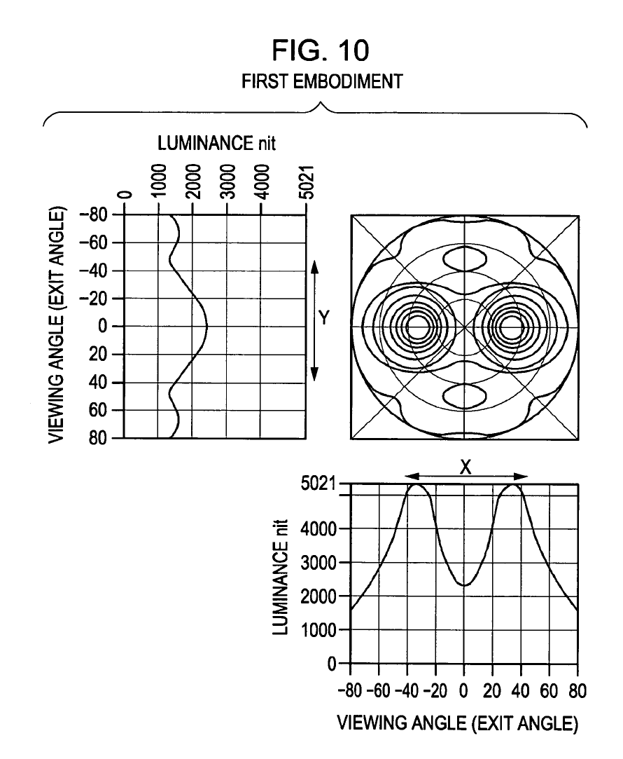

FIG. 10 shows data in relation to the lighting unit 110 according to a first embodiment, the lighting unit 110 including the planar light source 111 shown in FIGS. 1 and 2; the light diffuser 114 disposed adjacent to the emergent face of the planar light source 111; the first optical sheet 112 formed of the optical sheet OS1 shown in FIG. 5, the first optical sheet 112 being disposed adjacent to the viewing side of the light diffuser 114 in such a manner that the light-deflecting surface of the first optical sheet 112 is disposed adjacent to the planar light source, the smooth surface of the first optical sheet 112 is disposed adjacent to the viewing side, and that the prismatic faces face toward the X-direction; the second optical sheet 113 formed of the optical sheet OS1 shown in FIG. 5, the second optical sheet 113 being disposed adjacent to the viewing side of the first optical sheet 112 in such a manner that the smooth surface of the second optical sheet 113 is disposed adjacent to the planar light source, the light-deflecting surface of the second optical sheet 113 is disposed adjacent to the viewing side, and that the prismatic faces face toward the Y-direction; and the polarized light separator 115 disposed adjacent to the viewing side of the second optical sheet 113, the polarized light separator 115 being a reflection polarizer, which transmits a polarization component parallel to a predetermined direction and reflects a polarization component orthogonal to the predetermined direction.

In the first embodiment, with respect to luminance distribution along the X-direction, peaks of the luminance level are observed in directions at viewing angles of +30° and −30°. The luminance level in the direction of the normal (direction at a viewing angle of zero degree) is significantly low. In the first embodiment, a high luminance level is obtained by the use of the optical sheet OS1. The half-width of each peak is about 50° (+/−10° to +/−60°). In this case, satisfactory luminance level can be obtained (maximum luminance: 5021 nit) at viewing angles of +30°and −30°. The luminance levels around the peaks are also high in appropriate viewing angle ranges. The minimum luminance value at the intermediate position between the peaks, i.e., luminance at a viewing angle of zero degree, is less than the half-width value of each peak, which is satisfactorily low. Thus, for example, when this unit is used in an apparatus having the function of displaying two images described below, it is possible to clarify the boundary between two images.

### Second Embodiment

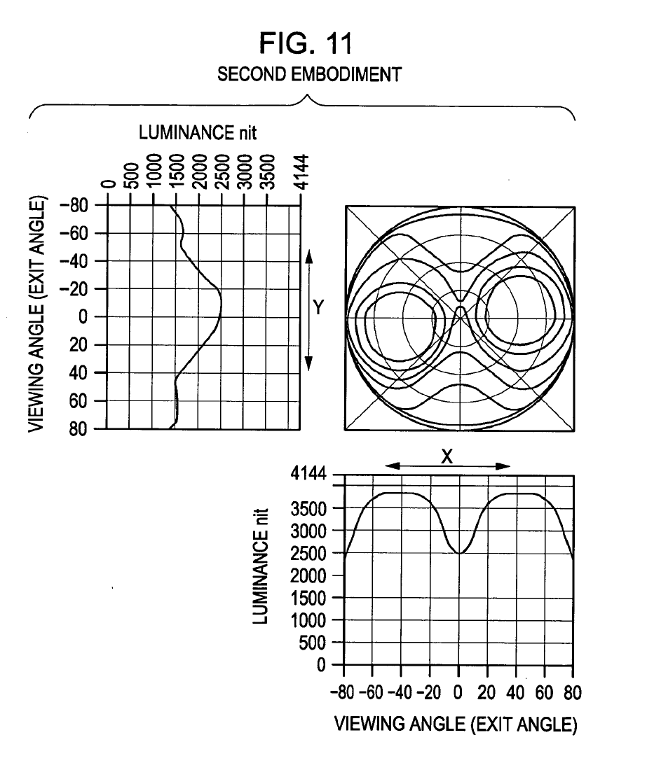

FIG. 11 shows data in relation to the lighting unit 110 according to a second embodiment, the lighting unit 110 including the planar light source 111 shown in FIGS. 1 and 2; the light diffuser 114 disposed adjacent to the emergent face of the planar light source 111; the first optical sheet 112 formed of the optical sheet OS2 shown in FIG. 6, the first optical sheet 112 being disposed adjacent to the viewing side of the light diffuser 114 in such a manner that the light-deflecting surface of the first optical sheet 112 is disposed adjacent to the planar light source, the smooth surface of the first optical sheet 112 is disposed adjacent to the viewing side, and that the prismatic faces face toward the X-direction; the second optical sheet 113 formed of the optical sheet OS2 shown in FIG. 6, the second optical sheet 113 being disposed adjacent to the viewing side of the first optical sheet 112 in such a manner that the smooth surface of the second optical sheet 113 is disposed adjacent to the planar light source, the light-deflecting surface of the second optical sheet 113 is disposed adjacent to the viewing side, and that the prismatic faces face toward the Y-direction; and the polarized light separator 115 disposed adjacent to the viewing side of the second optical sheet 113, the polarized light separator 115 being a reflection polarizer, which transmits a polarization component parallel to a predetermined direction and reflects a polarization component orthogonal to the predetermined direction.

In the second embodiment, with respect to luminance distribution along the X-direction, peaks of the luminance level are observed in directions at viewing angles of +30°and −30°. The luminance level in the direction of the normal (direction at a viewing angle of zero degree) is low. In the second embodiment, broad luminance distribution is obtained by the use of the optical sheet OS2. The half-width of each peak is about 80° (−/+50 to +/−75°). In this case, the maximum luminance is 4667 nit, which is slightly low. However, it is possible to obtain satisfactory luminance at viewing angles of +30° and −30°. Furthermore, The luminance levels around the peaks are also high in wide ranges. Note that the minimum luminance value at the intermediate position between the peaks, i.e., luminance at a viewing angle of zero degree, is the half-width value or more of each peak.

### Third Embodiment

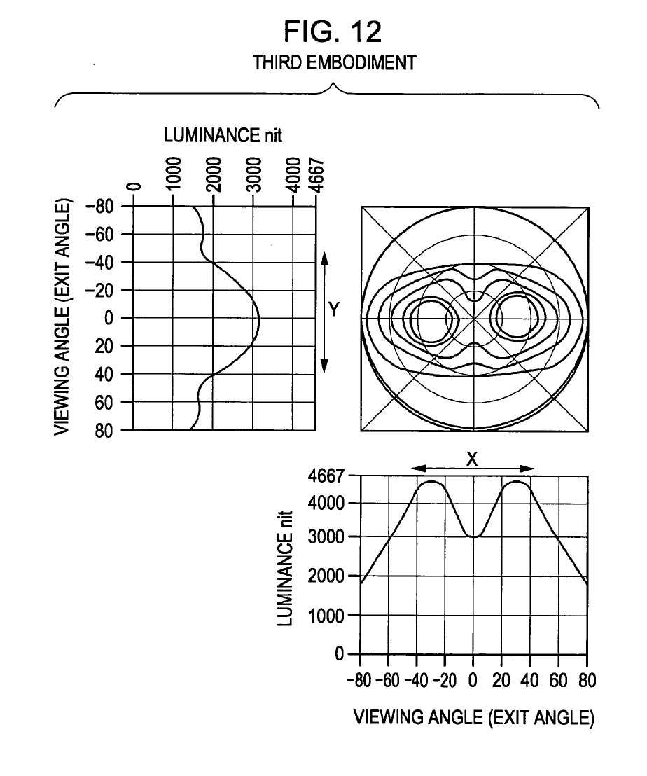

FIG. 12 shows data in relation to a lighting unit according to a third embodiment, the lighting unit including the planar light source 111 shown in FIGS. 1 and 2; the light diffuser 114 disposed adjacent to the emergent face of the planar light source 111; the second optical sheet 113 formed of the optical sheet OS2 shown in FIG. 6, the second optical sheet 113 being disposed adjacent to the viewing side of the light diffuser 114 in such a manner that the smooth surface of the second optical sheet 113 is disposed adjacent to the planar light source, the light-deflecting surface of the second optical sheet 113 is disposed adjacent to the viewing side, and that the prismatic faces face toward the Y-direction; the first optical sheet 112 formed of the optical sheet OS2 shown in FIG. 6, the first optical sheet 112 being disposed adjacent to the viewing side of the second optical sheet 113 in such a manner that the light-deflecting surface of the first optical sheet 112 is disposed adjacent to the planar light source, the smooth surface of the first optical sheet 112 is disposed adjacent to the viewing side, and that the prismatic faces face toward the X-direction; and the polarized light separator 115 disposed adjacent to the viewing side of the second optical sheet 113, the polarized light separator 115 being a reflection polarizer, which transmits a polarization component parallel to a predetermined direction and reflects a polarization component orthogonal to the predetermined direction. That is, the lighting unit in the third embodiment has the same structure as the lighting unit 110 according to the above-described embodiments shown in FIGS. 1 and 2, except that the first optical sheet 112 and the second optical sheet 113 change places with respect to the propagation direction of the illuminating light.

In the third embodiment, with respect to luminance distribution along the X-direction, peaks of the luminance level are observed in directions at viewing angles of +40° and −40°. The luminance level in the direction of the normal (direction at a viewing angle of zero degree) is low. In the third embodiment, broad luminance distribution is obtained by the use of the optical sheet OS2. The half-width of each peak is about 90° (−/+10° to +/−80°). In this case, the peak value is slightly low. However, it is possible to obtain satisfactory luminance in the viewing angle range of +20° to +60° and in the viewing angle range of −20° to −60°. Note that the minimum luminance value at the intermediate position between the peaks, i.e., luminance at a viewing angle of zero degree, is the half-width value or more of each peak.

In the third embodiment, the peak values of luminance are slightly low. However, since both of the peaks broaden, high luminance levels are ensured in wide ranges compared with those in the second embodiment. In the first embodiment, when the first optical sheet 112 and the second optical sheet 113 change places with respect to the propagation direction of the illuminating light in the same way as this embodiment, peaks of luminance broaden. However, it is possible to construct a lighting unit having a high luminance level as a whole, as compared with the case in the second embodiment.

### Comparative Embodiment

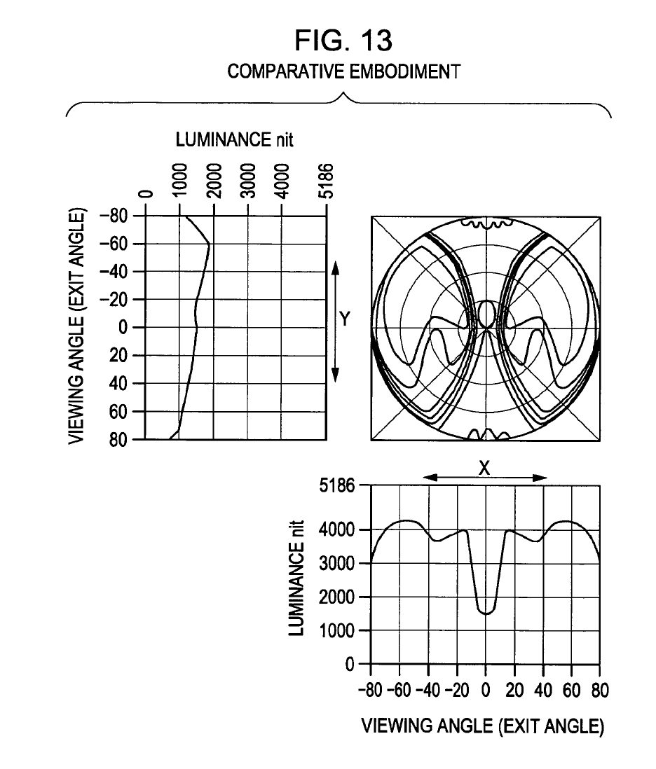

FIG. 13 shows data in relation to a lighting unit according to a comparative embodiment, the lighting unit including the planar light source 111 shown in FIGS. 1 and 2; the light diffuser 114 disposed adjacent to the emergent face of the planar light source 111; and the first optical sheet 112 formed of the optical sheet OS1 shown in FIG. 5, the first optical sheet 112 being disposed adjacent to the viewing side of the light diffuser 114 in such a manner that the light-deflecting surface of the first optical sheet 112 is disposed adjacent to the planar light source, the smooth surface of the first optical sheet 112 is disposed adjacent to the viewing side, and that the prismatic faces face toward the X-direction. The lighting unit according to the comparative embodiment has the same structure as in the above-described embodiment shown in FIGS. 1 to 3 but without the second optical sheet 113 and the polarized light separator 115.

In the comparative embodiment, with respect to luminance distribution along the X-direction, peaks of the luminance level are observed in directions at viewing angles of +50° and −50°. The luminance level in the direction of the normal (direction at a viewing angle of zero degree) is significantly low. In the comparative embodiment, the two peaks of luminance are obtained in the X-direction by the use of the first optical sheet. Although the maximum luminance is high, a range along the Y-direction is narrow. For example, with respect to the luminance distribution along the X-direction, luminance levels exceeding 4000 nit are obtained in the viewing angle range of 30° (+/−40° to +/−70°). As is apparent from the luminance distribution along the Y-direction, low-luminance regions expand toward large-viewing-angle regions in the X-direction as the viewing angle in the Y-direction (vertical direction) increases. Thus, when a viewer visually identifies an image displayed on a screen from a slightly vertically inclined direction, a range having suitable luminance level is significantly small.

The schematic structure of an electro-optic device 100 including the lighting unit 110 will be described below with reference to FIG. 4. FIG. 4 shows the schematic structure of the electro-optic device 100. The electro-optic device 100 includes the lighting unit 110 having the above-described structure; and an electro-optic display 120 disposed adjacent to the outgoing light side of the lighting unit 110. The light-emitting area A of the lighting unit 110 overlaps the display area B of the electro-optic display 120 so as to completely cover the display area B, when viewed from above.

The electro-optic display 120 is a liquid-crystal display (transmissive display) that includes a pair of substrates 121 and 122 each composed of glass, a plastic material, or the like; a seal 123; and a liquid crystal material 124 disposed between the substrates 121 and 122, the substrates 121 and 122 being bonded with the seal 123 at a predetermined distance. Electrodes 121a and an electrode 122a each composed of a transparent conductive material, such as indium tin oxide (ITO), are disposed on inner surfaces of the substrates 121 and 122, the inner surfaces facing to each other. Regions in which electrodes 121a overlap the electrode 122a when viewed from above function as pixels each having an optical state that can be independently controlled. When the liquid crystal material 124 constitutes a twisted-nematic (TN) liquid-crystal layer or a super-twisted-nematic (STN) liquid-crystal layer, polarizers 125 and 126 are disposed (bonded) on outer surfaces of the substrates 121 and 122, respectively.

In the electro-optic device 100, a predetermined light modulation is performed in every pixel by receiving illuminating light emitted from the lighting unit 110 to form an intended image on the display area B. As described above, in the exit angle distribution of luminance of the illuminating light emitted from the lighting unit 110, the peaks of luminance are observed at angles different from the direction of the normal to a screen (direction at an exit angle of zero degree). Thus, when viewers V1 and V2 visually identify an image displayed on the screen from the direction at the above-described exit angle, a bright image can be achieved.

In particular, in the lighting unit 110, two peaks of luminance are observed at right and left sides with respect to the direction of the normal to the screen. Thus, the electro-optic device 100 is suitable when an image is viewed from right and left directions with respect to the direction of the normal to the screen. The electro-optic device 100 is effective when the electro-optic device 100 is used as an in-car display, the screen being mounted at the middle portion in a car in the width direction in such a manner that the screen faces toward the rear of the car.

Another embodiment of the electro-optic device including the lighting unit 110 will be described below. FIG. 8 illustrates an example of a barrier-type two-image display 200 which includes a barrier having slits and light-shielding portions, the barrier being disposed at the viewing side of the display, and which can provide viewers at different positions with different images.

The electro-optic device 200 having the function of displaying the two images includes the lighting unit 110 and an electro-optic display 220 disposed at the outgoing light side of the lighting unit 110. The electro-optic display 220 includes an electro-optic panel 220L disposed adjacent to the lighting unit 110; and a barrier 220M, the electro-optic panel 220L being disposed between the lighting unit 110 and the barrier 220M. The electro-optic panel 220L basically has the same structure as the electro-optic display 120 shown in FIG. 4. The electro-optic panel 220L is configured in such a manner that two pixel lines R and L are alternately arranged along the X-direction and display different images by a controller or the like (not shown).

The barrier 220M is disposed adjacent to the viewer side with respect to the screen of the electro-optic panel 220L. The barrier 220M and the screen of the electro-optic panel 220L are separated by interval G The barrier 220M includes slits T and light-shielding portions S corresponding to the pixel lines R and L, the slits T and light-shielding portions S being alternately arranged along the X-direction. The viewers V1 and V2 located at right and left positions can visually identify images displayed on the screen of the electro-optic display 220 through the slits T. The barrier 220M may be formed of an electro-optic display, such as a liquid-crystal display, capable of independently controlling light transmittance of a plurality of regions.

The viewer V1 can visually identify the pixel lines R through the slits T but cannot visually identify the pixel lines L because of the light-shielding portions S. As a result, the viewer V1 visually identifies an image DR formed of the pixel lines R. On the other hand, the viewer V2 can visually identify the pixel lines L through the slits T but cannot visually identify the pixel lines R because of the light-shielding portions S. As a result, the viewer V2 visually identifies an image DL formed of the pixel lines L.

The viewer V1 located at right position and the viewer V2 located at left position can visually identify the different images DR and DL, respectively, displayed with the electro-optic device 200 having the above-described structure. In this case, the viewers V1 and V2 visually identify images from right and left directions with respect to the direction of the normal to the screen. When directions of the peaks of luminance of the lighting unit 110 in the X-direction are matched with the right and left direction, luminance in the directions from which the viewers V1 and V2 visually identify images can be increased. Thus, the brightness of the images DR and DL can be enhanced without increase in power consumption or change in the specification of the light source 111A.

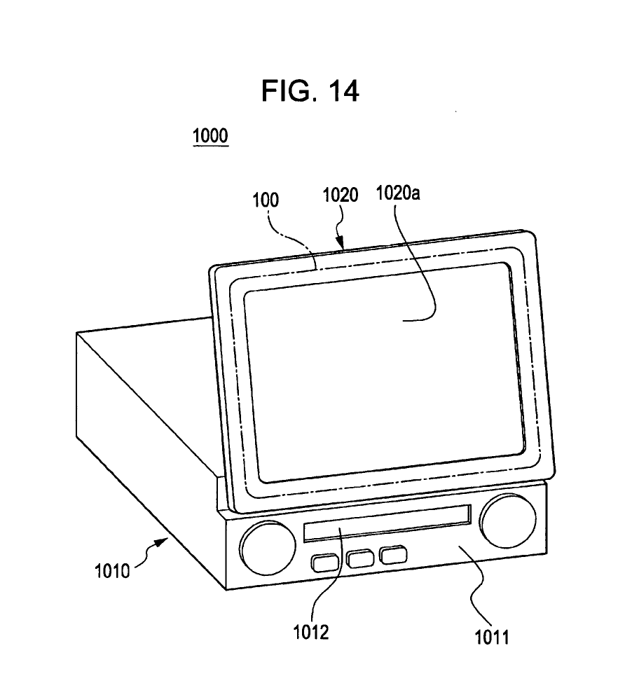

FIG. 14 is a schematic perspective view of an appearance of an example of an electronic apparatus. An exemplary electronic apparatus 1000 is a car navigation system and includes a main body 1010 and a display portion 1020 connected to the main body 1010. The main body includes an operation panel 1011 provided with operation buttons and the like; and a feed port for a recording medium, such as DVD. The electro-optic device 100 is incorporated in the display portion. Thereby, an image displayed by the electro-optic device 100, i.e., a navigation image displayed on a screen 1020a of the display portion 1020, can be visually identified.

A bright image can be visually identified from right and left directions with respect to the screen 1020a by incorporating the electro-optic device 100 in the electronic apparatus 1000. When the electro-optic device 200 is incorporated in place of the electro-optic device 100, viewers located in right and left oblique directions can visually identify different images at the same time. In this case, it is possible to brighten each image.

The electro-optic device and the electronic apparatus according to the embodiments of the invention are not limited to the embodiments shown in the figures. It will be obvious that various modifications may be made without departing from the scope of the gist of the invention.

For example, the electro-optic display according to the above-described embodiment is a liquid-crystal display including a liquid-crystal material as an electro-optic material. Alternatively, the electro-optic display may be another display, such as an electrophoresis display including another electro-optic material.

The lighting units according to the embodiments each include a sidelight-type (edge-light-type) backlight having a light source facing the end face of the light guide. In the invention, a backlight having a light source disposed at the back of a light guide may be used. Alternatively, a front light may be used in place of the backlight.

What is claimed is:

1. A lighting unit comprising:
a planar lighting component that emits illuminating light;
a first light deflector having a prismatic face on one surface, the first light deflector being disposed on the planar lighting component;
a second light deflector having a prismatic face on one surface, the second light deflector being disposed on the first light deflector;
wherein the one surface of the first light deflector is opposite the one surface of the second light deflector, and the direction of tilt of the prismatic face of the first light deflector is perpendicular to the direction of tilt of the prismatic face of the second light deflector.

2. A lighting unit comprising:
a planar lighting component that emits illuminating light;
a first light deflector disposed adjacent to an outgoing light side of the planar lighting component, the first light deflector deflecting the illuminating light in such a manner that the exit angle distribution of luminance along a first direction has at least two peak ranges separated from each other; and
a second light deflector disposed adjacent to an outgoing light side of the planar lighting component, the second light deflector deflecting the illuminating light in such a manner that the exit angle distribution of luminance along a second direction intersecting with the first direction concentrates in a small-exit-angle region.

3. The lighting unit according to claim 2, wherein the two peak ranges extend at both sides of a region with an exit angle of zero degree.

4. The lighting unit according to claim 2, wherein the minimum value of luminance between the two peak ranges is less than the half-width of a peak value.

5. The lighting unit according to claim 2, wherein the planar lighting component includes
a light guide having an emergent face and an entrance face facing to a direction different from the emergent face; and
a light source facing the entrance face, wherein the propagation direction of light from the light source through the entrance face is substantially identical to the second direction.

6. An electro-optic device comprising:
the lighting unit according to claim 1; and
an electro-optic display disposed adjacent to the outgoing light side of the lighting unit, wherein the electro-optic display includes
a pair of substrates, and
an electro-optic material disposed between the substrates.

7. The electro-optic device according to claim 6, wherein the electro-optic display displays different images in two different viewing angle ranges, and the lighting unit has peaks of luminance in exit angle ranges corresponding to the two viewing angle ranges.

8. An electronic apparatus comprising the electro-optic device according to claim 6.
